(19) United States
(12) Patent Application Publication
(10) Pub. No.: US 2003/0096072 A1
(43) Pub. Date: May 22, 2003

(54) Concrete formworks and method of making same

(76) Inventor: Gregory D. Johnson, Zionsville, IN (US)

Correspondence Address: PATTON BOGGS, PO BOX 270930, LOUISVILLE, CO, 80027, US

(21) Appl. No.: 09/993,733

(22) Filed: Nov. 21, 2001

(51) Int. Cl. B32B 1/08

(52) U.S. Cl. 428/36.91; 428/137; 428/172

(57) ABSTRACT

A concrete form is made using a plurality of formwork panels, each comprising a plastic core and a steel facing layer and a steel backing layer attached to the plastic core. Each panel is from 9 millimeters to 15 millimeters thick and weighs 77 pounds or less. A plurality of fasteners connect the panels. A steel support framework may support the panels. Concrete is poured into the form.

### BACKGROUND OF THE INVENTION

1. Field of the Invention

The invention in general relates to concrete formworks, and, more particularly, to structures and materials for concrete formworks and methods of manufacturing the same.

2. Statement of the Problem

Forms employed for holding and forming concrete while it cures, sometimes referred to as “formworks”, are well-known. There are several conventional types of forms: plywood forms supported by metal straps; plywood forms supported by a steel framework or rack; and solid steel formworks. The wood forms are generally used for smaller projects by contractors who do not require forms with long lifetimes. The systems with steel racks are generally used for larger projects, and the solid steel formworks are generally used for large commercial building projects and by contractors desiring lifetimes in the decades. Recently, because wood is becoming less plentiful and more expensive, there has been some discussion of the use of specialized dense plastics, such as crosslinked polymers, as a substitute for wood. See, for example, U.S. Pat. No. 6,117,521 issued Sep. 12, 2000 to Yoshida et al.

All of the above formworks have disadvantages. Wood fibers deteriorate each time the wood is used, and usually are not useable beyond one or two seasons. The steel racks permit the wood to be used for larger projects, but the wood still deteriorates. Steel systems are heavy and difficult for smaller operations to use effectively. Steel is also relatively expensive and thus requires a significant advance in capital to purchase. Plastics have not become generally accepted because, to be able to take the beating that wood and steel can take, dense plastics must be used, which end up being as heavy if not heavier than wood. Further, they have not proven to be economically advantageous because the cost of materials to make plastic have been increasing as fast as the cost of wood.

For the above reasons, it would be desirable to have a formwork material and system that is more durable than wood, less expensive, lighter, and easier to use than steel.

3. Solution to the Problem

The invention solves the above problem by providing a concrete formwork system made of metal-faced plastic. The invention provides a concrete formwork panel comprising: a plastic core; a metal facing layer attached to the plastic core; a metal backing layer attached to the plastic core; the panel being thicker than 7 millimeters (mm). The panel can be from 7 mm to 35 mm in thickness. Preferably, the panel ranges from 9 mm to 15 mm thick. Most preferably, the panel is about 12 mm thick. Preferably, the panel weighs 77 pounds or less. Preferably, the metal facing layer and the metal backing layer are steel. Preferably, one of the metal facing layer and the metal backing layer is made of 0.09 inch (0.23 mm) steel. Preferably, one of the metal facing layer and the metal backing layer is made of 0.013 inch (0.33 mm) steel. Preferably, one of the metal facing layer and the metal backing layer is made of 0.019 inch (0.48 mm) steel. Alternatively, the metal facing layer and the metal backing layer are aluminum. Preferably, the plastic is foam plastic. The foam may be from 10% to 70% gas by volume. Preferably, the foam plastic is 40% or more gas by volume. Alternatively, the foam plastic is 50% or more gas by volume. Preferably, the plastic is high density polyethylene. Preferably, the panel is bent to form a flange. Preferably, the flange has openings formed in it. Preferably, the panel is notched at the bend. Preferably, there are two of the bends and the flange is a double-thick flange. Preferably, the backings are attached to the plastic with adhesive.

In one embodiment, the panel is bent into a hollow columnar form. Preferably, the columnar form is cylindrical. Preferably, the panel has a first end and a second end, a portion of the plastic and the facing is removed from the first end and a portion of the plastic and the backing is removed from the second end, and the ends are joined with a portion of the backing of the first end overlapping the backing of the second end and a portion of the facing of the second end overlapping the facing of the first end.

The invention also provides a concrete formwork system comprising a plurality of concrete formwork panels as described above and a plurality of fasteners fastening the plurality of panels together. Preferably, the formwork system further comprises a support framework adjacent the backing. Preferably, the framework comprises steel frame members.

The invention also provides a method of making a concrete formwork material comprising: extruding a plastic core; forming a sandwich of a metal facing layer, a first adhesive layer, the plastic core, a second adhesive layer, and a metal backing layer, the sandwich being thicker than 7 millimeters (mm); and heating the sandwich to form the formwork material. The panel can be from 7 mm to 35 mm in thickness. Preferably, the panel ranges from 9 mm to 15 mm thick. Most preferably, the panel is about 12 mm thick. Preferably, the metal backing layer and the metal facing layers are steel sheets between 0.008 inches (0.20 mm) and 0.025 inches (0.6 mm) thick.

The invention also provides a method of forming concrete comprising: providing a concrete formwork panel comprising a plastic core; a metal facing layer attached to the plastic core; and a metal backing layer attached to the plastic core; forming a concrete form using the concrete formwork panel; and pouring concrete into the concrete form. Preferably, the step of providing comprises providing a plurality of the concrete formwork panels and a plurality of fasteners; and the step of forming comprises forming the concrete form using the plurality of formwork panels and the fasteners. Preferably, the plastic is foam plastic. Preferably, the plastic is high density polyethylene. Preferably, one of the metal facing and the metal backing comprises steel. Preferably, the step of providing further comprises providing a support framework, and the step of forming comprises supporting the concrete formwork panel with the support framework. Preferably, the support framework comprises steel frame members.

The metal/plastic sandwich system according to the invention not only provides concrete formworks that are more durable and less expensive than wood, but are also lighter and easier to handle. Numerous other features, objects and advantages of the invention will become apparent from the following description when read in conjunction with the accompanying drawings.

### BRIEF DESCRIPTION OF THE DRAWINGS

FIG. 1 shows a preferred embodiment of a formwork panel according to the invention;

FIG. 2 is a cross-sectional view of the tri-layered concrete formwork material according to the preferred embodiment of the invention taken through the line 2-2 of FIG. 1;

FIG. 3 shows an example of a formwork fastener;

FIG. 4 shows a piece of cut sheet of formwork material;

FIG. 5 illustrates the bending of the formwork material to make the formwork panel of FIG. 1;

FIG. 6 shows a notched sheet of formwork material;

FIG. 7 illustrates how the notched formwork material of FIG. 6 is bent to form a corner;

FIG. 8 illustrates an alternative embodiment of a formwork panel according to the invention utilizing the notched corner of FIG. 7;

FIG. 9 shows a top plan view of a concrete formwork according to the invention;

FIG. 10 illustrates the bending without notching of a formwork sheet according to the invention;

FIG. 11 shows a top plan view of an alternative concrete formwork according to the invention;

FIG. 12 illustrates an alternative formwork panel having an architectural detail impressed into the panel;

FIG. 13 illustrates another alternative embodiment of a formwork panel according to the invention utilizing a double layer flange;

FIG. 14 shows a top plan view of a columnar formwork element according to the invention just prior to its being joined;

FIG. 15 illustrates a concrete highway divider mold made from the formwork material according to the invention;

FIG. 16 illustrates a concrete culvert mold according to the invention; and

FIG. 17 illustrates a concrete formwork system according to the invention in which the formwork panels are additionally supported by a support framework.

### DESCRIPTION OF THE PREFERRED EMBODIMENT

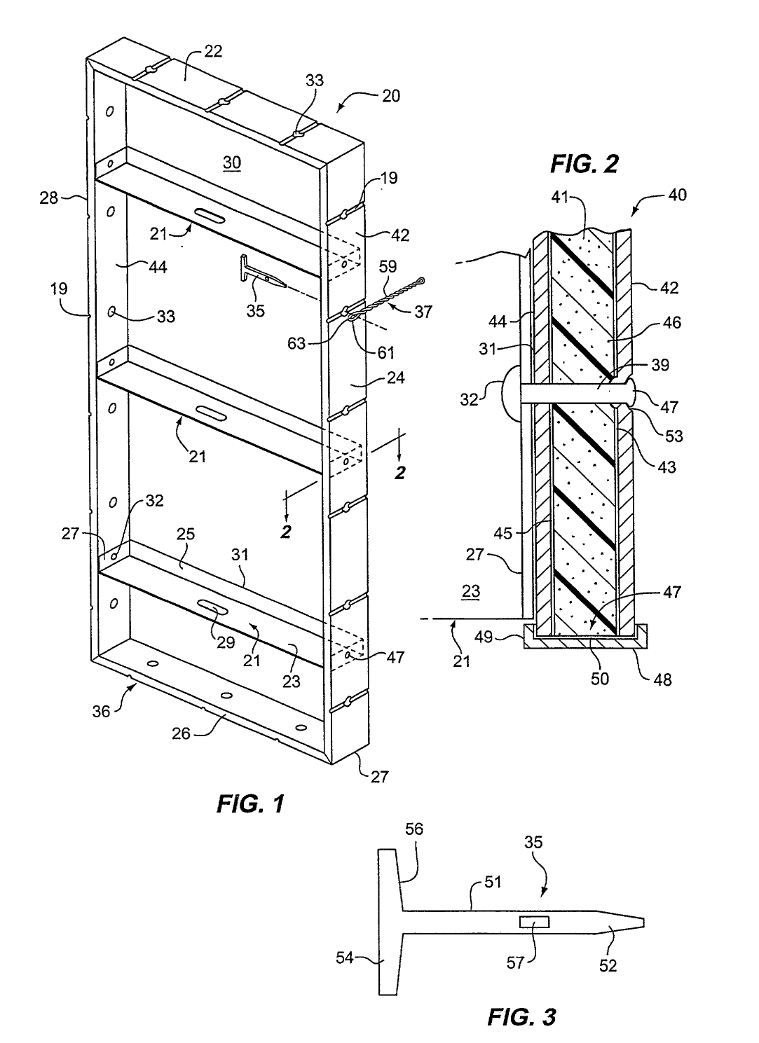

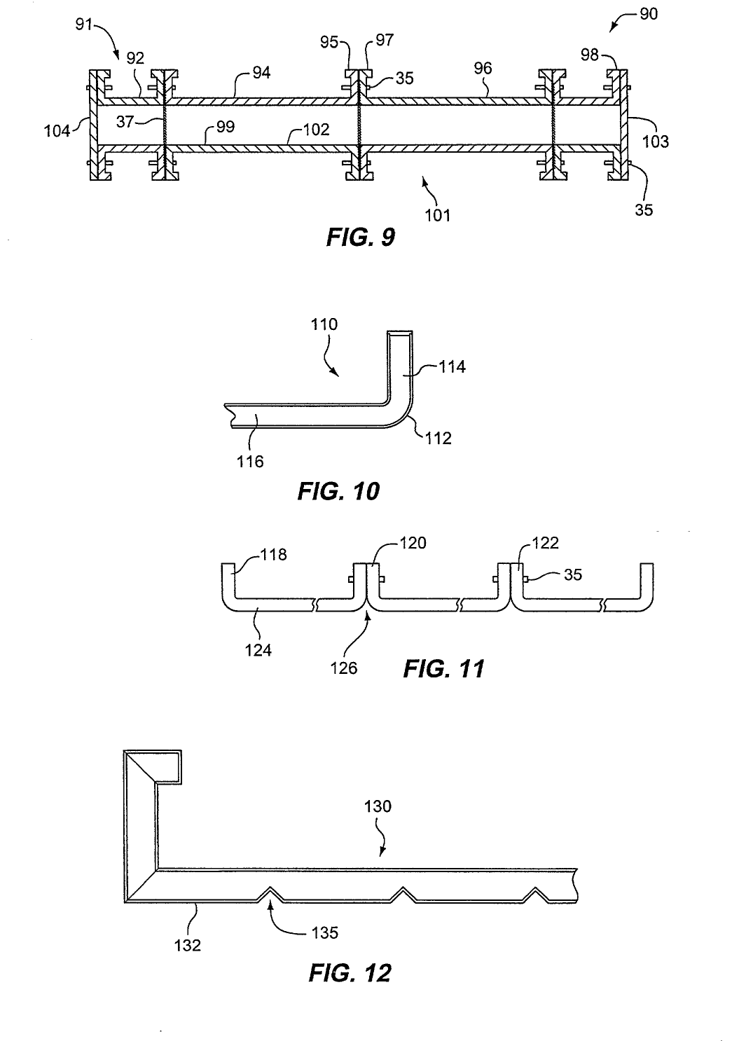

FIG. 1 is a perspective view of a concrete formwork panel 20 according to the invention which forms a part of a concrete formworks assembly 90 (FIG. 9). Panel 20 includes a plate 30 with flanges 22, 24, 26, and 28 attached to the two sides and ends. Flanges 22, 24, 26, and 28 have openings, such as 33 and grooves 19, formed in them. In the embodiment shown, openings, such as 33, are oval slots. Fasteners, such as wedge bolts 35, fit into slots, such as 33, to permit fastening panel 20 to other similar panels. It is a feature of the invention that panel 20 is formed of a sheet 40 of novel structure, which is shown in FIG. 2, which is a cross-section through line 2-2 of FIG. 1. Panel sheet 40 comprises a three-layered sandwich, the three layers being a plastic core 41, a metal facing 42, and a metal backing 44. Facing 42 and backing 44 are firmly attached to core 41, preferably using adhesive layers 43 and 45, respectively. The exposed end 47 of core 41 is sealed with a seal 48. In the embodiment shown, seal 48 is a rectangular cap 48 which is secured to the end 47 with adhesive 50. Adhesive 50 preferably extends between the rim 49 of cap 48 and the facing 42 and backing 44.

It should be understood that the dimensions of the various elements of the drawings are not drawn to scale, since otherwise it would not be possible to clearly illustrate the entire structure on a single page. For example, metal backing layers are much thinner in comparison to the thickness of core 41 than shown, and adhesive 43, 45 and 50 is extremely thin in comparison to core 41.

Plastic core 41 is preferably made of a high density plastic, such as high density polyethylene. While “high density polyethylene” may appear to be vague to one not skilled in the plastics art, one skilled in the plastics art readily recognizes this material.

As known in the art, polyethylene is a thermoplastic, and was first discovered about 50 years ago. There are two types of polyethylene, low and high density. Those skilled in the art recognize that these are made by different processes. To produce low density polyethylene, ethylene is first obtained by refining the gas. It is then compressed, a peroxide is added as a catalyst and chain modifier and hydrogen or carbon tetrachloride are also added. Polymerization occurs at elevated temperature, after which the polymer is extruded in ribbon form, cooled and granulated. High density polyethylene is obtained from gaseous ethylene fed into an inert hydrocarbon solvent with a catalyst. Polymerization occurs at atmospheric pressure and at moderate temperature. The slurry output is then dried and the polymer separated. Most preferably, the plastic core 41 is a foam plastic containing gas 46. The percentage of gas in the foam by volume can be from 10% to 70%. Preferably, the plastic foam is at least 40% gas by volume, and most preferably, 50% or more. Facing 42, backing 44, and end cap 48 are preferably made of steel, though aluminum or other metal may also be used. Adhesive 43, 45 and 50 is preferably a heat sensitive plastic adhesive such as an adhesive referred to as “tie layer” in the art, but can be any other conventional suitable adhesive. As known in the art, the tie layer adhesive is a modified high density polyethylene similar to the polyethylene used in the core 41. The panel sheet 40 is preferably made by extruding the plastic, filling it with gas under pressure as it is extruded, cooling it between nitrogen-cooled rollers until it is firm, then hot rolling the metal 42, adhesive 43, plastic core 41, adhesive 45, and metal 44 together to melt plastic adhesive 43 and 45. End caps 48 may be applied at the same time, though preferably they are applied in a second operation after the sheet 40 has stabilized. Seals 48 may alternatively be a lacquer, epoxy or other sealing agent that is applied in fluid form and permitted to dry, a portion of foam 41 that extends beyond the facing 42 and backing 44 and then is melted with a hot iron to create a seal, or any conventional device or system for sealing foam plastic.

Returning to FIGS. 1 and 2, panels 20 preferably also include ribs 21. Ribs 21 may comprise any member that serves to strengthen the panel structure. In the embodiment shown, ribs 21 comprise a cross-member 23 having a back flange 25 and a pair of end flanges 27. Preferably, cross-member 23 has an opening 29, which is preferably elongated along the longer dimension of cross-member 23 and bores, such as 22 on end flanges 27. Ribs 21 are fastened to plate 30 and flanges 24 and 28 with an adhesive 31 and rivets 39. Rivets 39 pass through bores 32 in flanges 27 and through the adjoining flange, such as 24. A dimple 53 is formed in facing 42 and core 41 so that the head 47 of rivet 39 is flush with the surface of facing 42.

Ribs 21 not only strengthen panel 20, but also permit workers to more easily handle panels 20 and to climb on the assembly 90 (FIG. 9) after it is constructed. Opening 29 is a handhold, and is shaped so that a human hand can comfortably fit into the opening to grasp cross-member 23. Opening 29 can take other forms, such as an additional flange, a member welded to rib 21, or a roughened surface on rib 21 allowing it to be grasped more easily. In FIG. 1, three ribs 21 are shown. However, more or less ribs can be used.

Referring to FIGS. 1 and 9, concrete formworks assembly 90 is held together with a fastener system 36 that includes fasteners 35 and ties 37, together with grooves 19 in flanges 22, 24, 26, and 28. Ties 37 are preferably thin strips 59, preferably of a metal such as steel, with a pair of looped ends 61 having openings 63. Preferably, they are formed by twisting a looped strand of steel wire, and are made in different lengths to facilitate making concrete structures of different thickness. FIG. 3 shows an embodiment of a fastener 35 according to the invention. Fasteners 35 preferably comprise conventional wedge bolts, which include a pin 51 having one wedge shaped end 52 and one T-shaped end 54. An elongated slot 57 that is approximately as wide as the width of pin 51 is formed in pin 51. Wedge bolt pin 51 is tapered along its length. As known in the art, wedge bolts 35 are used by passing the end 52 of one wedge bolt through an opening, such as 33, and driving a second wedge bolt through opening 57 in the first wedge bold until friction holds the wedge bolts in place. The length of pin 51 from the inside surface 56 of end 54 to opening 57 is approximately twice the width of panel sheet 40, so that when two panels are placed together and the slots in the panels aligned and a wedge bolt is slipped through an aligned pair of slots and a second wedge bolt is inserted into opening 57 of the first wedge bolt, the two wedge bolts hold the two panels together with a friction fit. A tie 37 may also be inserted between the flanges (FIG. 9), such as 95 and 97 of adjoining panels, such as 95 and 96, by passing wedge bolt 35 through opening 63 in tie end 61. The strip portion 59 fits into groove 19 so that the tie does not create a space between adjacent panel flanges, such as 95 and 97. As best shown in FIG. 9, ties 37 hold opposing panels walls, such as 91 and 101 position with correct spacing. As known in the art, after the concrete has hardened and the concrete formworks assembly 90 is disassembled, ties 37 are broken off and left in the concrete.

Fasteners 35 are preferably made of steel, but can also be made of other metals, plastic or other suitable material. It should be understood that the fastener system 36 according to the invention, including fasteners 35 and slots 33, is just one of many different fastener systems that may be used. Slots 33 can be replaced by circular, rectangular, square, triangular or other shaped bores, and bolts and nuts of the appropriate shape can replace fastener 35. Other alternatives are clips that attach to the edges of flanges 22, 24, 26, 28, plastic or soft metal snap-fit pin and clip systems that attach semi-permanently and then are cut off when the assembly is disassembled, mating pins and holes on alternate panels, and any other conventional fastening system. Grooves 19 and dimples 53 are preferably formed in a press, though the force of the riveting process is in some instances sufficient to produce the dimple 53.

Panel sheet 40 is at least 7 mm thick, i.e., the horizontal direction through the panel material in FIG. 2 from the outside of facing 42 to the outside of backing 44. In general, the panel sheet 40 can be from 7 mm to 35 mm in thickness. Preferably, the thickness ranges from 9 mm to 15 mm thick. Most preferably, the panel sheet thickness is about 12 mm thick. Otherwise, panel 20 may be made with any convenient set of dimensions. Plate 30 is typically 8 feet (2.43 meters) by 2 feet (0.6 meters), flanges 22, 24, 26, 28 are typically 2.5 inches (6 cm), and, as just mentioned, the thickness of panel material 40 is typically 0.5 inches (1.27 cm). Facing 42, backing 44, and the metal of end caps 48 is typically 0.009 inch (0.23 mm) sheet metal, but may also be 0.013 inch (0.33 mm) or 0.019 inch (0.48 mm) sheet metal. Preferably, the plastic and metal dimensions of panels 20 are selected so that each panel weighs 77 pounds or less. This weight is such that a panel can be handled by a single worker, if necessary, and easily handled by two workers.

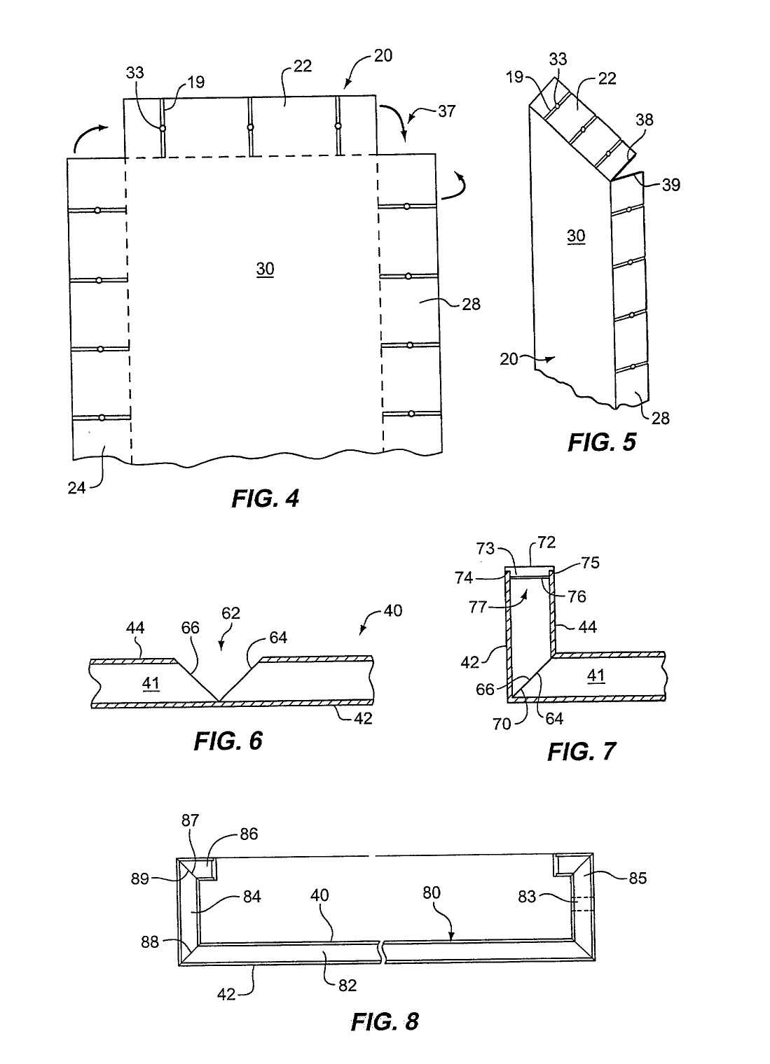

FIGS. 4 and 5 illustrate how panel 20 is formed from a single sheet of material 40. Corners 37 are cut from a rectangular sheet of material 40 to form flanges 22, 24, 26, and 28 which are bent as shown by arrows to form panel 20. The edges, such as 38 and 39 of flanges 22, 24, 26, and 28, are fastened by a melt adhesive or other fastening mechanism. Preferably, the corners, such as 27 and 29 (FIG. 1), are square. FIGS. 6 and 7 illustrate how a square corner is made. A notch 62, preferably having sides 64 and 66 sloping at 45 degrees, is cut into panel material 40 through backing 44 and plastic 41 to the rear side of facing 44. Facing 44 is then bent through a 90° angle so that sides 64 and 66 of notch 62 meet. A thin layer of adhesive 70 is applied at the interface of sides 64 and 66, preferably an epoxy or other conventional adhesive.

FIG. 7 also illustrates an alternative embodiment of seal 48, namely end cap 72. End cap 72 is rectangular having a plug portion 73 that is as wide as or just slightly wider than the thickness of plastic core 41 and flanges 74 and 75 that are the same thickness as facing 42 and backing 44, respectively. A small amount of plastic 41, the same depth as the length of plug 73, is routed out at end 77 and a thin layer of adhesive 76 is inserted before the insertion of cap 72. Preferably, end cap 72 is metal, most preferably, steel, and adhesive 76 is a thermally sensitive plastic that is melted to seal cap 72 to end 77. Any of the other adhesives mentioned above may be used also. Cap 72 may also be made of a dense polyethylene or other suitable material.

Turning now to FIG. 8, a cross-section of an alternative embodiment of a panel 80 according to the invention is shown. Panel 80 is made of the same material 40 as panel 20. Like panel 20, it includes slots, such as 83, a sheet portion 82 and four end flanges, two of which, 84 and 85, are shown. The corners 88 of end flanges 84 and 85 and sheet 82 are preferably square. However, flanges 84 and 85 each have a short foot 86 formed by an additional square corner 89. Corner 89 is formed in the same manner as corner 88 as described above. Foot 86 protects and strengthens end 87 of flange 84. Preferably, the length of flange 84 from facing 42 to the end 87 of foot 86 is 2.5 inches (6 cm), though the length can vary considerably. In the embodiment of FIG. 8, the upper and lower flanges, corresponding to flanges 22 and 26 in FIG. 1, preferably do not have the additional foot, but if they do, flanges 22 and 26 are made slightly longer to permit the foot to overlap the feet 86 of the side flanges. Foot 86 also provides additional area to attach and support an upper flange, such as 22, and also makes it easier to handle panel 80.

FIG. 9 is a cross-section of a formworks assembly 90 illustrating how a concrete formworks assembly 90 may be formed from panels such as 92, 94, 96, and 98. For example, flanges 95 and 97 of panels 94 and 96 are abutted and fastened together with fasteners, such as 35. Similarly, the other panels 92 and 98 are abutted and fastened to form one wall 91 of concrete formworks assembly 90. Ties 37 are inserted as needed to hold opposing wall sections 91 and 101 together. As shown, panels 92, 94, 96, and 98 of a typical formworks system are made in many different lengths so that any length of wall may be made. An opposing formwork assembly wall 101 is formed facing wall 91, end panels 103 and 104 are attached at each end with fasteners 35, and concrete is poured so that it contacts facing 99 and 102. Another formworks assembly similar to assembly 90 may be formed on top of assembly 90 and attached by fastening the upper and lower flanges 22 and 26 (FIG. 1) together. FIG. 9 also illustrates how formwork portions, such as end pieces 103 and 104, may take many other forms as necessary to complete various possible structures.

Turning to FIG. 10, there is shown an illustration of a panel 110 in which a rounded corner 112 is formed. Panel 110 is made of the same material 40 as panels 20 and 80. In this case, no notch is cut out before bending, but the entire panel is simply bent at corner 112 to form panel sheet 116 and flange 114. Three such panels 118, 120 and 122 are shown attached by fasteners 35 in FIG. 11. As indicated at 126, where the panels are joined, a dimple is formed in the concrete which contacts facing 124. This can be disadvantageous or advantageous, depending on the architectural needs. FIG. 12 shows a cross-section of a panel 130 similar to panel 80 of FIG. 8 except that architectural detailing, such as 135, is impressed on the facing 132. Detailing 135 will cause thin ribs to form in the concrete, which is architecturally attractive and can have functional purposes also. Detailing 135 can take many different forms, limited only by artistic imagination.

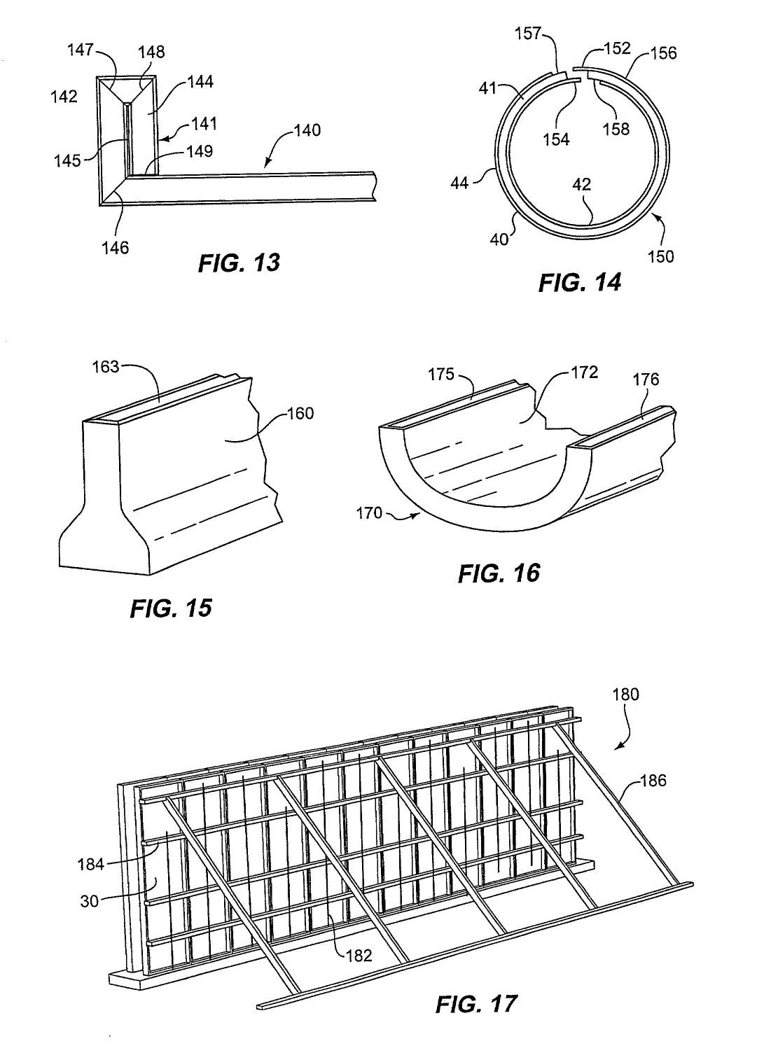

FIG. 13 is a cross-section of another embodiment of a panel 140 according to the invention illustrating yet another flange possibility. In this case, a flange 141 is formed by three square corners 146, 147 and 148. This creates a double-thick flange 141 including a first flange member 142 and a second flange member 144, which may be attached by an additional adhesive layer 145, which preferably is an epoxy, but may also be a heat sensitive plastic adhesive or any of the other adhesives mentioned above. This embodiment has the advantage that no metal cap is necessary on end 149, since this end is protected. However, a sealant, such as an epoxy, is preferably used to seal and secure end 149.

Turning now to FIG. 14, a plan view of a columnar panel 150 is shown. Panel 150 is made of the same material 40 as the other panels. In this case, a single sheet 156 of material 40 is curved and the ends 157 and 158 of sheet 156 are fastened to form a cylinder. Preferably, at one end 157 a portion of backing 44 and plastic 41 are cut away leaving a tongue 154 of facing, and at the other end 158 a portion of facing 42 and plastic 41 are cut away leaving a tongue 152 of backing. Ends 157 and 158 are abutted, tongue 152 is overlapped on backing 44, and tongue 154 is overlapped on facing 42, with a heat sensitive plastic adhesive placed between each of the parts in contact, and the joint thus formed is heated to melt the adhesive and form a joint that is essentially as strong as material 40. In this way, a form for a cylindrical concrete column is made. Utilizing appropriate bends and architectural detailing as discussed above, columns of almost any shape and design may be made. As discussed earlier, other adhesives, such as epoxy, may also be used.

FIGS. 15 and 16 illustrate other concrete forms that may be made utilizing the techniques of notching, routing, bending and attaching using adhesives and attaching using fasteners 35 as discussed above. Formwork 160 is a form for a concrete highway divider that has an opening 163 that is filled with concrete. Formwork 170 is a form for a concrete culvert that has openings 175 and 176 that are filled with concrete, usually from one end or the other to prevent air pockets from being formed. The details of these forms are not shown; however, based on the above disclosures, those skilled in the art of concrete formworks will understand how these forms are made. FIG. 17 illustrates that the formworks according to the invention may be utilized in combination with a support framework 180. Support framework 180 comprises vertical supports 182, horizontal supports 184 and braces 186. Such support frameworks are known in the art for use with conventional plywood concrete forms, and can be used in the same way with the formwork panels, such as 20, 80, and 140, according to the invention.

There has been described a novel sheet material 40 for use in concrete formworks, a novel method of making such formwork sheet material 40, and methods of manufacturing and forming formwork systems using the material. While the invention has been described in terms of specific embodiments, it should be understood that the particular embodiments shown in the drawings and described within this specification are for purposes of example and should not be construed to limit the invention which will be described in the claims below. Further, it is evident that those skilled in the art may now make numerous uses and modifications of the specific embodiments described, without departing from the inventive concepts. For example, now that the advantage of utilizing a sandwich of metal and lightweight plastic for concrete formworks has been described, other metals and plastics than those described can be substituted. It is also evident that equivalent structures and processes may be substituted for the various structures and processes described. Consequently, the invention is to be construed as embracing each and every novel feature and novel combination of features present in and/or possessed by the concrete formworks described.

I claim:

1. A concrete formwork panel comprising:
a plastic core;
a metal facing layer attached to said plastic core;
a metal backing layer attached to said plastic core;
said panel being thicker than 7 millimeters (mm).

2. A concrete formwork panel as in claim 1 wherein said panel ranges from 9 mm to 15 mm thick.

3. A concrete formwork panel as in claim 1 wherein said panel is 12 mm thick.

4. A concrete formwork panel as in claim 1 wherein said panel weighs 77 pounds or less.

5. A concrete formwork panel as in claim 1 wherein said metal facing layer and said metal backing layer are steel.

6. A concrete formwork panel as in claim 1 wherein one of said metal facing layer and said metal backing layer is made of 0.09 inch (0.23 mm) steel.

7. A concrete formwork panel as in claim 1 wherein one of said metal facing layer and said metal backing layer is made of 0.013 inch (0.33 mm) steel.

8. A concrete formwork panel as in claim 1 wherein one of said metal facing layer and said metal backing layer is made of 0.019 inch (0.48 mm) steel.

9. A concrete formwork panel as in claim 1 wherein said metal facing layer and said metal backing layer are aluminum.

10. A concrete formwork panel as in claim 1 wherein said plastic is foam plastic.

11. A concrete formwork panel as in claim 10 wherein said foam plastic is 40% or more gas by volume.

12. A concrete formwork panel as in claim 10 wherein said foam plastic is 50% or more gas by volume.

13. A concrete formwork panel as in claim 1 wherein said plastic is high density polyethylene.

14. A concrete formwork panel as in claim 1 wherein said panel is bent to form a flange.

15. A concrete formwork panel as in claim 14 wherein said flange has openings formed in it.

16. A concrete formwork panel as in claim 14 wherein said panel is notched at said bend.

17. A concrete formwork panel as in claim 16 wherein said bend is a 90° bend.

18. A concrete formwork panel as in claim 14 wherein there are two of said bends and said flange is a double-thick flange.

19. A concrete formwork panel as in claim 1 wherein said panel is bent into a hollow columnar form.

20. A concrete formwork panel as in claim 19 wherein said columnar form is cylindrical.

21. A concrete formwork panel as in claim 19 wherein said panel has a first end and a second end, a portion of said plastic and said facing is removed from said first end and a portion of said plastic and said backing is removed from said second end, and said ends are joined with a portion of said backing of said first end overlapping said backing of said second end and a portion of said facing of said second end overlapping said facing of said first end.

22. A concrete formwork panel as in claim 1 wherein said facing has an architectural detail impressed in it.

23. A concrete formwork panel as in claim 1 and further including a strengthening rib attached to said metal backing layer.

24. A concrete formwork panel as in claim 23 wherein said strengthening rib includes a handhold.

25. A concrete formwork panel as in claim 1 wherein said facing and said backing are attached to said plastic with adhesive.

26. A concrete formwork system comprising a plurality of concrete formwork panels as in claim 1 and a plurality of fasteners fastening said plurality of panels together.

27. A concrete formwork system as in claim 26 and further comprising a support framework adjacent said backing.

28. A concrete formwork system as in claim 27 wherein said framework comprises steel frame members.

29. A method of making a concrete formwork material comprising:
extruding a plastic core;
forming a sandwich of a metal facing layer, a first adhesive layer, said plastic core, a second adhesive layer, and a metal backing layer, said sandwich being thicker than 7 millimeters (mm); and
heating said sandwich to form said formwork material.

30. A method as in claim 29 wherein said sandwich ranges from 9 mm to 15 mm thick.

31. A method as in claim 29 wherein said metal backing layer and said metal facing layers are steel sheets between 0.008 inches (0.20 mm) and 0.025 inches (0.6 mm) thick.

32. A method of forming concrete comprising:
providing a concrete formwork panel comprising a plastic core; a metal facing layer attached to said plastic core; and a metal backing layer attached to said plastic core;
forming a concrete form using said concrete formwork panel; and
pouring concrete into said concrete form.

33. A method as in claim 32 wherein said step of providing comprises providing a plurality of said concrete formwork panels and a plurality of fasteners; and
said step of forming comprises forming said concrete form using said plurality of formwork panels and said fasteners.

34. A method as in claim 32 wherein said plastic is foam plastic.

35. A method as in claim 32 wherein said plastic is high density polyethylene.

36. A method as in claim 32 wherein one of said metal facing and said metal backing comprises steel.

37. A method as in claim 32 wherein said step of providing further comprises providing a support framework, and said step of forming comprises supporting said concrete formwork panel with said support framework.

38. A method as in claim 37 wherein said support framework comprises steel frame members.
